(19) United States
(12) Patent Application Publication
(10) Pub. No.: US 2012/0193299 A1
(43) Pub. Date: Aug. 2, 2012

(54) WATER TREATMENT PLANT AS WELL AS A METHOD AND COMPUTER PROGRAM FOR OPERATING A WATER TREATMENT PLANT

(76) Inventor: Andreas Mattern, Karlsruhe (DE)

(21) Appl. No.: 13/139,993

(22) PCT Filed: Oct. 20, 2009
(86) PCT No.: PCT/EP2009/063728

§ 371 Date: Apr. 13, 2012

(30) Foreign Application Priority Data
Dec. 16, 2008 (DE) 102008054727.1

(51) Int. Cl. C02F 1/00; B01D 69/00; B01D 37/04

(52) U.S. Cl. 210/739; 210/141

(57) ABSTRACT

A water treatment plant is described having a filter element situated between a water inlet line for raw water and a water discharge line for purified water, having a pump unit for pumping, in particular pressing and/or drawing, the water through the filter element, having at least one purifying unit for the filter element, having sensors for detecting water properties, and having a control unit connected to the sensors for activating the at least one purifying unit. It is provided that the control unit includes a computer program for adaptively activating the at least one purifying unit or adaptively changing the volume flow of the pump unit. Furthermore, a method for operating a water treatment plant and a computer program is also described.

### FIELD OF THE INVENTION

The present invention relates to a water treatment plant, a method for operating a water treatment plant and a computer program.

### BACKGROUND INFORMATION

A water treatment plant may be used for treating both drinking water and process water. Both conventional methods for treating water using, for example, sand or activated carbon filters as well as plants using membrane filters are known. The major advantage of membrane-based treatment plants is that they represent an absolute, i.e. impenetrable barrier for, for example, bacteria as long as the membrane is intact. This reliability and several additional aspects make it possible to automate the plant to a great degree, making it unnecessary for operating personnel to be present. This makes it possible to use smaller, decentralized water treatment plants economically. These plants are increasingly designed as standardized systems whose modular design makes it possible for them to be adapted to requirements such as the necessary flow rate.

Dirt particles in water treatment plants are deposited continuously and must be removed regularly, for example, by backwashing. Depending on the water composition, heavy deposits, so-called fouling, which cannot be removed by simple backwashing or flooding, are also produced as a function of operating parameters such as, for example, flow rate, pH value, floculation additives as well as substances in water. To remove the fouling, a chemically supported purification process is needed, typically using acids, bases or substances based on oxidation/chlorination.

It is seen as a disadvantage in standardized water treatment plants that they are not optimally adapted to fluctuations of, for example, the raw water composition resulting, for example, from heavy rains. The reason for this is that, due to the needed process reliability, for example, with regard to the purification intervals, fixed, periodic intervals are specified, or they are coupled to a certain differential pressure on the membrane. For that reason, the operating costs in the known plants are not optimized to the detriment of operating reliability.

### SUMMARY OF THE INVENTION

An object of the exemplary embodiments and/or exemplary methods of the present invention is to refine the known water treatment plant in such a way that it adjusts its operating parameters to the instantaneous water composition and thus makes optimized operation possible. This optimized operation results in particular in reduced operating costs. The object is further to specify a method for operating a water treatment plant and a computer program provided for it.

This objective is achieved by a water treatment plant having the features described herein, by the features with respect to the method and by the features with respect to the computer program. Advantageous refinements of the exemplary embodiments and/or exemplary methods of the present invention are also specified herein. All combinations of at least two of the features summarized in the description, the claims and/or the figures are within the scope of the present invention. For the purpose of avoiding repetition, features summarized according to the device are to be regarded and be claimable as summarized according to the method. Likewise, features summarized according to the method are to be regarded and be claimable as summarized according to the device.

It is seen as advantageous in particular to store the measured values of the operating parameters detected by the individual sensors in a memory device. These measured values may then be processed in the computer program in such a way that the chronological sequence of the measured values is considered when the purifying unit and/or the pump unit is/are activated.

It is furthermore advantageous to provide an operating unit via which it is possible to enter or select data of individual operating parameters. This results in high flexibility in particular with respect to changing boundary conditions or the possibility for optimizing the water treatment plant with regard to various operating parameters.

To that end, it is provided in a particular specific embodiment to detect both energy and material consumption of components of the water treatment plant using sensors, thus further increasing the flexibility of the water treatment plant for optimizing individual operating parameters.

Additional advantages, features and details of the present invention are provided by the following description of exemplary embodiments and on the basis of the drawing.

### BRIEF DESCRIPTION OF THE DRAWING

The FIGURE shows a schematic representation of a water treatment plant.

### DETAILED DESCRIPTION

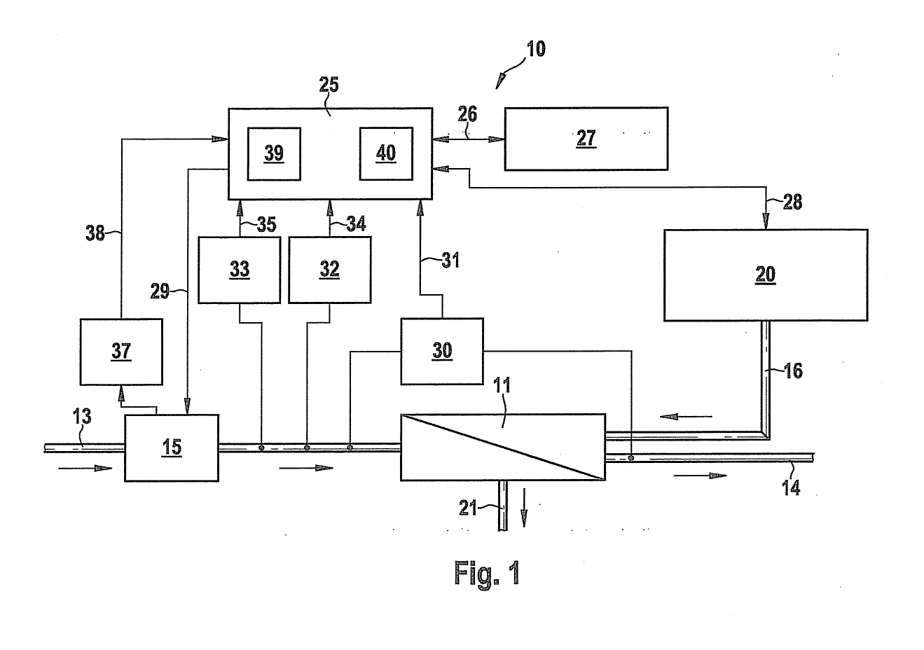

A water treatment plant 10 is shown in FIG. 1. Water treatment plant 10 has a filter element 11. Filter element 11 may be configured as a membrane filter element, in particular as a hollow fiber membrane element having pores suitable for ultra- and microfiltration. Filter element 11 is connected between an inlet line 13 for the raw water and a discharge line 14 for the water purified by filter element 11. A pump unit 15 for the water is situated in inlet line 13, it being possible to regulate the power and accordingly the flow rate of the pump unit. Instead of a regulatable pump unit 15, it is also conceivable to regulate the volume flow using a flow control valve. It is of course also possible as an alternative to situate pump unit 15 in discharge line 14 and draw the water through filter element 11. Alternatively, it is possible to provide a common line as an inlet line/discharge line, which may have a suitable valve.

Filter element 11 is coupled to a purifying or rinsing unit 20 via a line 16. Depending on the requirement or technology, instead of a single purifying or rinsing unit 20, a plurality of various purifying or rinsing units may of course be connected to filter element 11, which include, for example, separate containers or inlet lines for purifying or rinsing substances. Finally, a discharge line 21 emerging from filter element 11 is provided via which residues or backwash water may be discharged.

Water treatment plant 10 further includes a control unit 25, which is also used in particular for activating purifying or rinsing unit 20. Control unit 25 is coupled to an operating unit 27 via a control line 26, it being possible to use the control unit for inputting relevant data for operating data and/or selecting operating parameters to be optimized, which will be explained in greater detail in the following. Control unit 25 may furthermore be connected to other relevant entities via a data line or via the Internet in a manner known per se.

Control unit 25 and the one or a plurality of purifying or rinsing units 20 are connected to one another via a bidirectional data line 28. Using another control line 29, control unit 25 controls pump unit 15.

Water treatment plant 10 as described thus far is additionally equipped with a number of sensors. The sensors include, for example, and therefore not exclusively, a differential pressure sensor 30, which is connected between inlet line 13 and discharge line 14 of filter element 11, and which is connected to control unit 25 via a line 31. Furthermore, a turbidity sensor 32 and a temperature sensor 33 connected in inlet line 13 are provided, these sensors being connected to control unit 25 via lines 34, 35. Furthermore, a sensor 37 is provided for detecting the power consumption of pump unit 15, the sensor being coupled to control unit 25 via a line 38.

The control of water treatment plant 10 using control unit 25 is based in particular on the operating parameters named in the following: the volume flow of the water, the interval between rinsings using purifying or rinsing unit(s) 20 and the rinsing time and, if necessary, the rinsing pressure. If chemical detergent substances are present, this also includes the time interval between two purifications, the purification time, the purification temperature, the detergent concentration and the type of detergent used. If additional auxiliary agents such as floculating agents are used, their added amount is linked to the volume flow or the concentration of the contaminant.

If not already mentioned above, all relevant operating parameters for controlling water treatment plant 10 may be detected by sensors and fed to control unit 25 as particular input variables.

According to the exemplary embodiments and/or exemplary methods of the present invention, it is essential that control unit 25 provides a computer program 40 which adjusts the operation of water treatment plant 10 to the composition or quality of the raw water adaptively, i.e. independently, and responds automatically to fluctuations in the water composition. In particular, the activation of purifying or rinsing unit 20 (which, as already mentioned, operates using either rinsing water alone or with additional chemical substances) and/or, for example, the flow rate on pump unit 15 should be optimized in such a way that, everything considered, the operating costs in particular are optimized, i.e., they reach a minimum. Here, it should be noted that the operating costs represent an indirect operating parameter of water treatment plant 10 which result as a function of the individual, forenamed (direct) operating parameters.

To this end, the measured values of the operating parameters detected via the various sensors are stored in control unit 25 in a measured value memory 39 or used as input variables in an algorithm or plurality of algorithms in computer program 40. Here, the algorithm or algorithms should independently develop their own operating strategies or vary the forenamed operating parameters in a window predefined as reasonable in order to achieve minimum operating costs in particular depending on the water composition. These operating parameters and their relevant properties are predefined using operating unit 27 and are, if necessary, variable or adaptable so that the present invention should not only be limited to optimizing operating costs.

It should be mentioned as an example that for a specific water quality, a minimum of operating costs is achieved for a specific water quantity, for example, at a specific rinsing interval having a specific rinsing time combined with a specific addition of chemical detergent substances and a specific flow rate. If the water quality changes, a new minimum of operating costs may be achieved at a reduced flow rate, extended purification interval at a simultaneously extended rinsing time and increased addition of detergent substances. Using computer program 40, the operating parameters are constantly updated according to the momentary water composition (while taking into consideration the chronological sequence of the water composition and the chronological sequence of the operating parameters) for the purpose of minimizing the operating costs overall. As a result, computer program 40 controls via control unit 25 purifying or rinsing unit 20 or pump unit 15 in line with demand for the purpose of minimizing the operating costs.

1-8. (canceled)

9. A water treatment plant, comprising:
a filter element situated between a water inlet line for raw water and a water discharge line for purified water;
a pump unit for pumping by at least one of pressing and drawing the water through the filter element;
at least one purifying unit for the filter element;
at least one sensor for detecting water properties; and
a control unit connected to the at least one sensor for activating the at least one purifying unit;
wherein the control unit includes a computer program for at least one of (i) independently adjusting activation of the at least one purifying unit as a function of water properties detected by the at least one sensor, and (ii) independently adjusting a change of the volume flow of the pump unit as a function of the water properties detected by the at least one sensor.

10. The water treatment plant of claim 9, wherein the control unit has a storage unit for storing sensor data.

11. The water treatment plant of claim 9, wherein an operating unit, which is coupled to the control unit, provides for the selection of operating parameters and for the input of data regarding the operating parameters.

12. The water treatment plant of claim 9, wherein the filter element is a membrane filter, which is a hollow fiber filter element.

13. The water treatment plant of claim 9, wherein sensors additionally connected to the control unit are provided for detecting one of (i) the energy consumption of the pump unit, and (ii) at least one of the energy consumption and material consumption of other components of the water treatment plant.

14. A method for operating a water treatment plant, the method comprising:
processing, with the control unit for activating the at least one purifying unit or for regulating the flow rate on pump unit, measured values of operating parameters detected by sensors in at least one algorithm; and
adaptively activating the at least one purifying unit or the pump unit as a function of the instantaneously detected measured values of the sensors while taking into consideration the optimization of one or a plurality of direct or indirect operating parameters;
wherein the water treatment plant includes:
a filter element situated between a water inlet line for raw water and a water discharge line for purified water;
a pump unit for pumping by at least one of pressing and drawing the water through the filter element;
at least one purifying unit for the filter element;
at least one sensor for detecting water properties; and
a control unit connected to the at least one sensor for activating the at least one purifying unit.

15. The method of claim 14, wherein the at least one purifying unit or the pump unit is activated while taking into consideration the chronological sequence of the measured values of the sensors stored in a memory unit.

16. A computer readable medium having a computer program, which is executable by a processor, comprising:
a program code arrangement having program code for operating a control unit of a water treatment plant by performing the following:
processing, with the control unit for activating the at least one purifying unit or for regulating the flow rate on pump unit, measured values of operating parameters detected by sensors in at least one algorithm; and
adaptively activating the at least one purifying unit or the pump unit as a function of the instantaneously detected measured values of the sensors while taking into consideration the optimization of one or a plurality of direct or indirect operating parameters;
wherein the water treatment plant includes:
a filter element situated between a water inlet line for raw water and a water discharge line for purified water;
a pump unit for pumping by at least one of pressing and drawing the water through the filter element;
at least one purifying unit for the filter element;
at least one sensor for detecting water properties; and
a control unit connected to the at least one sensor for activating the at least one purifying unit.
